(19) United States
(12) Patent Application Publication
(10) Pub. No.: US 2009/0283931 A1
(43) Pub. Date: Nov. 19, 2009

(54) Molded Bodies Containing Polyacetals and Method for Producing Said Molded Bodies

(75) Inventors: Bernhard Pfeiffer, Wellbach (DE); Rainer Bemstein, Gross-Umstadt (DE)

Correspondence Address: DORITY & MANNING, P.A., POST OFFICE BOX 1449, GREENVILLE, SC, 29602-1449, US

(73) Assignee: Ticona GmbH, Kelsterbach (DE)

(21) Appl. No.: 12/508,883

(22) Filed: Jul. 24, 2009

Related U.S. Application Data
(62) Division of application No. 10/527,334, filed on Sep. 26, 2005.

(30) Foreign Application Priority Data
Sep. 10, 2002 (DE) 102-42-186.2

(51) Int. Cl. B29C 45/46

(52) U.S. Cl. 264/240

(57) ABSTRACT

The present invention relates to moldings encompassing polyacetals, where the molding has a microcellular structure. The moldings have excellent mechanical properties. Furthermore, the moldings have very little tendency toward stress cracking. Processes for production of inventive moldings are also disclosed.

The present invention relates to polyacetal-containing moldings with wall thickness differences, having particularly excellent mechanical and chemical properties. The present invention also relates to processes for producing these polyacetal moldings.

Moldings composed of polyacetals have been known for a long time, and these moldings intrinsically have a good property profile. However, some applications need moldings which have particularly high mechanical stability. Addition of additives generally improves mechanical properties. However, this method is expensive, and in particular impairs the recycling capability of the plastics.

The wall thickness of the moldings can also be enlarged. However, this method is materials-intensive and therefore resource-intensive, and these components are also heavier. However, in many sectors, e.g. in automotive construction, attempts are being made to save weight by reducing the wall thicknesses of the moldings. Accordingly, this method, too, has associated disadvantages.

Although polyacetals generally exhibit very little tendency toward stress cracking, there is also a need to improve this property. This applies particularly to specialty applications in which particularly high value is placed upon a very small tendency toward formation of defects of this type.

It was therefore an object of the present invention to provide polyacetal-containing moldings with wall thickness differences, having particularly high mechanical stability. Another object of the present invention was therefore to provide moldings having particularly little tendency toward stress cracking. The moldings of the present invention should moreover be capable of particularly simple and low-cost production. The molding should also be capable of recycling without any particularly high cost.

These objects are achieved via moldings with all of the features of claim 1.

The result is provision of moldings which have high mechanical stability. For example, the inventive moldings exhibit, in particular in relation to their very low dead weight, high screw-insertion torque, and also high overtorque, in each case measured with 2 D screw-insertion depth and 500 rpm at 23° C. The moldings of the present invention moreover exhibit particularly little tendency toward stress cracking.

The wall thickness of the inventive moldings can be within a wide range. The moldings preferably have a wall thickness of up to 100 mm, in particular up to 10 mm, and particularly preferably up to 5 mm. In this context it should be stated that the wall thickness of the moldings can also have differences. Preferred moldings have wall thickness differences, the difference between minimum wall thickness and maximum wall thickness in particular being at least 1 mm, preferably at least 3 mm, and particularly preferably at least 5 mm. The ratio of maximum wall thickness to minimum wall thickness, other than that applying to the perforations, is preferably in the range from 1.1 to 100, in particular from 2 to 50, and particularly preferably from 4 to 20.

The average wall thickness of the molding can be calculated by dividing the volume of the composition forming the molding, inclusive of the microcellular structure, by the surface area of the molding, where this surface area is calculated from the entire surface of the molding. For this, the entire surface is divided by two in order to arrive at the surface area. The average wall thickness of the molding is preferably in the range from 0.1 to 100 mm, preferably from 0.5 to 10 mm and particularly preferably from 1 to 5 mm.

Polyacetals are an essential constituent of the inventive moldings. These are polyoxymethylene homo- and/or copolymers, and for the purposes of the invention these include either a homopolymer on its own, two or more homopolymers in a mixture with one another, a copolymer on its own, two or more copolymers in a mixture with one another, and also mixtures which have one or more homopolymers together with one or more copolymers.

The polyacetals form the main constituent of the molding compositions used to produce the moldings of the invention. The polyoxymethylenes may be homopolymers of formaldehyde or of trioxane, or copolymers of trioxane. They may have a linear structure, or else may have branching or crosslinking. They may be used individually or as a mixture.

For the purposes of the present invention, homopolymers of formaldehyde or of trioxane include those polymers whose semiacetal hydroxyl end groups have been chemically stabilized, for example by esterification or etherification, to resist degradation. For the purposes of the present invention, copolymers of trioxane are copolymers made from trioxane and from at least one compound copolymerizable with trioxane.

The homopolymers generally have thermally stable end groups, such as ester groups or ether groups. The copolymers of formaldehyde or of trioxane advantageously have more than 50%, in particular more than 75%, of oxymethylene groups. Copolymers which have proven particularly successful are those where at least 0.1% by weight of groups of the copolymer have at least two adjacent carbon atoms within the chain. Polyoxymethylenes which have gained particular industrial importance are those which contain from 1 to 10% by weight of comonomers.

For the purposes of the invention, preferred polyoxymethylene copolymers are those which, besides the —CH₂O— repeat units also have up to 50 mol %, preferably from 0.1 to 20 mol %, and in particular from 0.3 to 10 mol %, of repeat units

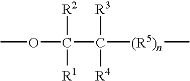

where R¹ to R⁴, independently of one another, are hydrogen, C₁-Cₓ-alkyl, or halogen-substituted alkyl having from 1 to 4 carbon atoms, and R⁵ is —CH₂—, —CH₂O—, or C₁-C₄-alkyl- or C₁-C₄-haloalkyl-substituted methylene, or a corresponding oxymethylene group, and n is from 0 to 3. These groups may advantageously be introduced into the copolymers by ring-opening of cyclic ethers. Preferred cyclic ethers are those of the formula

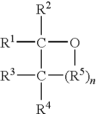

where R¹ to R⁵ and n are as defined above.

Particularly suitable comonomers are compounds of the formula

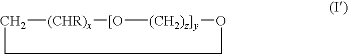

where R is a hydrogen atom, an alkyl radical which has from 1 to 6 carbon atoms, preferably 1, 2, or 3 carbon atoms, and may have substitution by 1, 2, or 3 halogen atoms, preferably chlorine atoms, or is an alkoxymethyl radical having from 2 to 6 carbon atoms, preferably 2, 3, or 4 carbon atoms, or is a phenyl radical, or is a phenoxymethyl radical, x is an integer from 1 to 3, where y is 0, or y is an integer from 1 to 3, where x is 0 and z is 2, or z is an integer from 3 to 6, preferably 3 or 4, where x is 0 and y is 1.

Particularly suitable cyclic ethers are epoxides, e.g. ethylene oxide, styrene oxide, propylene oxide, or epichlorohydrin, and also glycidyl ethers of mono- or polyhydric alcohols or phenols.

Particularly suitable cyclic acetals are cyclic formals of aliphatic or cycloaliphatic α,ω-diols having from 2 to 8 carbon atoms, preferably 2, 3, or 4 carbon atoms, the carbon chain of which may have interruption by an oxygen atom at intervals of 2 carbon atoms, e.g.:
glycol formal (1,3-dioxolane),
propanediol formal (1,3-dioxane),
butanediol formal (1,3,dioxepan), and
diglycol formal (1,3,6-trioxocane), and also
4-chloromethyl-1,3-dioxolane,
hexanediol formal (1,3-dioxonane), and
butenediol formal (1,3-dioxa-5-cycloheptene).

Suitable linear polyacetals are either homo- or copolymers of the cyclic acetals defined above, or else linear condensates made from aliphatic or cyclo-aliphatic α,ω-diols with aliphatic aldehydes or thioaldehydes, preferably formaldehyde. Use is particularly made of homopolymers of cyclic formals of aliphatic α,ω-diols having from 2 to 8 carbon atoms, preferably 2, 3, or 4 carbon atoms, e.g. poly(1,3-dioxolane), poly(1,3-dioxane), or poly(1,3-dioxepan).

The viscosity numbers of the polyoxymethylenes used according to the invention (measured on a solution of the polymer in hexafluoroisopropanol adjusted to pH 8 to 9 using methanolic sodium hydroxide, at 25° C. at a concentration of 0.3 g/100 ml) should generally be at least 160 (ml/g). The crystalline melting points of the polyoxymethylenes are from 140 to 180° C., preferably from 150 to 170° C., and their densities are from 1.38 to 1.45 g×ml⁻¹, preferably from 1.40 to 1.43 g×ml⁻¹ (measured to DIN 53 479). The polyoxymethylenes used generally have a number-average molecular weight Mₙ of from 2000 to 200000, preferably from 10000 to 100000, and a volume flow index (melt volume rate, MVR) of from 0.5 to 200 cm³/10 min, preferably from 1 to 70 cm³/10 min, at 190° C. with an applied weight of 2.16 kg, to DIN ISO 1133.

The trioxane copolymers used according to the invention, preferably binary or ternary trioxane copolymers, are prepared in a known manner by polymerizing the monomers in the presence of catalysts with cationic action at from 0 to 150° C., preferably from 70 to 140° C. (cf. e.g. DE-B 14 20 283). Examples of catalysts used here are Lewis acids, such as boron trifluoride or antimony pentafluorlde, and complex compounds of Lewis acids of this type, preferably etherates, e.g. boron trifluoride diethyl etherate, or boron trifluoride di-tert-butyl etherate. Protic acids are also suitable, e.g. perchloric acid, as are compounds of salt type, e.g. triphenylmethyl hexafluorophosphate or triethyloxonium tetrafluoro-borate, acetyl perchlorate, or esters of perchloric acid, e.g. methoxymethyl perchlorate or tert-butyl perchlorate. To regulate the molecular weight, use may be made of any substance known to act as a chain-transfer agent in the polymerization of trioxane. The polymerization may take place in bulk, suspension, or solution. To remove unstable fractions, degradation until primary alcohol end groups are present (cf. e.g. DE-B 14 45 273 and 14 45 294).

The homopolymers of formaldehyde or of trioxane used according to the invention are likewise prepared In a known manner by catalytic polymerization of the monomer (cf. e.g. DE-B 10 37 705 and 11 37 215).

Polymers which have achieved very particular importance are those built up from trioxane and from 1 to 10% by weight of ethylene oxide, 1,3-dioxolane, or butanediol formal. Preferred compounds which may also be used as additional comonomers for trioxane are those having more than one polymerizable group in the molecule, e.g. alkyl glycidyl formals, polyglycol diglycidyl ethers, alkanediol diglycidyl ethers, e.g. 1,4-butanediol diglycidyl ether, or bis(alkanetriol) triformals. Diformals, e.g. diglycerol diformal, are also suitable, in particular for preparing terpolymers of trioxane.

The amounts usually used of these are from 0.05 to 5% by weight, preferably from 0.1 to 2% by weight, based on the total amount of monomer.

The amount of the polyacetals preferably present in the molding is at least 40% by weight, advantageously at least 70% by weight, and in particular at least 95% by weight, based on the weight of the molding.

The molding composition for production of the inventive moldings may also comprise conventional additives and reinforcing materials, e.g. fibers, in particular glass fibers, carbon fibers, aramid fibers, mineral fibers, processing aids, polymeric lubricants, lubricants with external and/or internal lubricant action, ultrahigh-molecular-weight polyethylene (UHMWPE), polytetrafluoroethylene (PTFE), or a graft copolymer which is a product of a graft reaction of an olefin polymer and an acrylonitrile-styrene copolymer, antioxidants, coupling agents, waxes, nucleating agents, mold-release aids, glass beads, mineral fillers, such as chalk, calcium carbonate, wollastonite, silicon dioxide, talc, mica, montmorillonite, organically modified or unmodified, organically modified or unmodified phyllosilicates, materials which form nanocomposites with the liquid-crystalline plastic or with the polyarylene sulfide, or nylon nanocomposites, or mixtures of the abovementioned substances.

The lubricants used may comprise a mixture of a lubricant with external lubricating action and a lubricant with internal lubricating action. The mixing ratio of lubricant with internal lubricating action to the lubricant with external lubricating action may be from 0:100 to 100:0 part by weight. The lubricants used with predominantly external lubricating action may comprise solid and/or liquid paraffins, montanic esters, partially hydrolyzed montanic esters, stearic acids, polar and/or nonpolar polyethylene waxes, poly-α-olefin oligomers, silicone oils, polyalkylene glycols, and perfluoroalkyl ethers. Soaps and esters, including those which have been partially hydrolyzed, are lubricants with both external and internal lubricating action. Preference is given to the use of a high-molecular-weight polyethylene wax which has been oxidized and is therefore polar. It improves tribological behavior and permits the fall-off in mechanical properties to be less marked. Stearyl stearate is preferably used as lubricant with predominantly internal lubricating action.

Paraffins, solid or liquid, stearic acids, polyethylene waxes, nonpolar or polar, poly-α-olefin oligomers, silicone oils, polyalkylene glycols, and perfluoroalkyl ethers are lubricants with external lubricating action. Soaps and esters, including those which have been partially hydrolyzed, are lubricants with both external and internal lubricating action. Montanic esters and partially hydrolyzed montanic esters are lubricants with external lubricating action.

The preferred oxidized polyethylene wax is a high-molecular-weight, polar wax and generally has an a cid value of from 12 to 20 mg KOH/g and a viscosity of from 3000 to 5000 mPa·s at 140° C.

Mention should be made of the following lubricants with predominantly internal lubricating action: fatty alcohols, dicarboxylic esters, fatty esters, fatty acid, fatty-acid soaps, fatty amide, wax esters, and stearyl stearates, the last-named being preferred. Lubricants are described in Gächter/Müller, “Taschenbuch der Kunststoff-Additive” [Handbook of Plastics Additives], 3^{rd} edition, Carl Hanser Verlag Munich/Vienna 1994, pp. 478-504, incorporated herein by way of reference.

The moldings of the present invention have a microcellular structure. The expression “microcellular structure” means that the molding encompasses cavities or cells whose size is a few hundred micrometers. These cells generally have uniform distribution within the composition forming the molding, but no resultant restriction is intended.

These cells generally have a spherical shape, but no resultant restriction is intended. For the purposes of the present invention, the term “spherical” means that the cells preferably have a spherical shape, but it is obvious to the person skilled in the art that the pressure conditions in the mold during injection molding can also give cells with another shape within the molding, or that the shape of the cells can deviate from the ideal spherical shape.

The term “spherical” therefore means that the ratio of the largest dimension of the cells to the smallest dimension is not more than 4, preferably not more than 2, each of these dimensions being measured through the center of gravity of the cells. At least 70% of the cells are preferably spherical, particularly preferably at least 90%, based on the number of cells.

The size of the cells, the diameter in the case of spherical cells, is preferably in the range from 1 to 100 μm, in particular from 3 to 80 μm, and particularly preferably in the range from 5 to 50 μm. This size is the average determined over the number of cells present, and can be determined, inter alia, via scanning electron micrographs.

A consequence of the microcellular structure is that the density of the composition which forms the molding and encompasses the volume of the cells of the microcellular structure is generally below the density of the molding composition prior to production of the molding having a microcellular structure. The density of the molding is preferably in the range from 1.0 to 1.6 g/cm³, in particular from 1.2 to 1.5 g/cm³, and particularly preferably from 1.3 to 1.4 g/cm³. This density is generally lower by from 2 to 50%, preferably from 5 to 30%, and particularly preferably from 10 to 25%, than the density of the molding composition prior to production of the molding. This variable can be determined by measuring the density of the molding, and then melting the molding, if appropriate devolatilizing it, and determining the density of the cooled melt. The composition forming the molding loses the microcellular structure through the melting process.

The flow path length of the inventive molding is not per se critical and accordingly can be within a wide range. However, this variable is preferably in the range from 1 mm to 250 cm, in particular from 2 mm to 200 cm, and particularly preferably in the range from 5 mm to 140 cm. This variable describes the length of the path between the injection point and that point in the molding which is furthest from this injection point. By way of example, this variable may be determined via direct measurement on the molding or on the mold, and the flow path to be traversed by the molding composition within the mold is to be determined here.

This variable can also be indirectly estimated. In this process, the flow path of the molding composition is measured within a spiral whose diameter is the same as the average wall thickness of the molding. The flow path length of the molding can then be determined by determining the limiting viscosity of the molding composition. The limiting viscosity indicates the maximum viscosity at which the straight mold is completely filled, the viscosity being measured at the injection point. At higher viscosity, the mold does not become completely filled, and defects therefore arise. The limiting viscosity thus determined serves to determine the flow path of the molding composition within the spiral. A significant factor here is that the processing conditions selected for determining the flow path length within the spiral are the same as those for production of the molding. For example, the viscosity of the molding composition, the mold temperature and melt temperature, the injection pressure, etc. must be identical.

In one particular embodiment of the present invention, the ratio of flow path length to wall thickness difference is in the range from 0.1 to 1000, preferably from 1 to 500, and particularly preferably from 3 to 100, without any intended resultant restriction.

The term “perforation” indicates an area where the wall thickness of the molding assumes the value 0. Molding composition completely surrounds this area, and the third dimension here is the wall thickness.

In one particular embodiment of the present invention, preferred moldings have at least one, in particular at least two, and particularly preferably at least ten, perforations.

The perforations preferably have an area of at least 1 mm² in particular at least 4 mm², and particularly preferably at least 10 mm², this variable relating to the total of the areas of all of the perforations.

In one aspect of the present invention, the moldings may, inter alia, have sharp corners, edges, ribs, fillets, screw domes, snap hooks, and/or film hinges.

The moldings of the present invention may, Inter alia, also comprise metal, such as iron, in particular steel, nickel, tin, zinc, chromium, copper, or else alloys of these metals. By way of example, these moldings may be obtained via metal overmolding processes, inter alia via what is known as Outsert technology. These moldings have particularly high strength and durability, and this relates in particular to cracking of the plastic, the level of cracking in the inventive moldings being particularly small when comparison is made with conventional moldings.

The moldings of the present invention have excellent mechanical properties. For example, the moldings preferably have an overtorque of at least 7.8 Nm, in particular at least 8.0 Nm. The screw-insertion torque for preferred moldings is at least 2.5 Nm, in particular at least 2.6 Nm. These variables may be determined using screw-insertion depth of 2 D and 500 rpm at 20° C.

The moldings have particularly low tendency toward stress cracking. For example, preferred moldings have no stress cracks within 5 minutes, in particular 10 minutes, after 5 minutes of immersion in 50% strength sulfuric acid at 20° C.

In a particular aspect of the present invention, the inventive moldings are produced via injection molding processes. It is preferable that, based on the total weight of the resultant mixture, up to 30% by weight, preferably from 10⁻⁸ to 5% by weight, in particular from 10⁻⁴ to 2% by weight, particularly preferably from 0.01 to 1% by weight, of a fluid in supercritical state is added to the melt encompassing polyacetal. The fluid and the polymer melt are, if appropriate, sheared and mixed by well-known processes, e.g. in an extruder or kneader, whereupon the fluid becomes dissolved in the polymer melt.

In one particular embodiment of the present invention, the amount selected of the fluid may be such that the viscosity of the solution of the fluid in the polymer melt is up to 60% below the viscosity of the pure polymer melt. These viscosity values may be regulated, Inter alia, via the amount of the fluid.

The mixture is rapidly charged to an injection mold. The hold pressure contributed by the gas pressure can be reduced down to 0. The injection pressure is generally selected in such a way as to be below, by up to 45%, advantageously up to 30%, in particular up to 20%, the injection pressure usually needed when using a polymer melt encompassing polyacetals. Preferred values are in the range from 200 to 2000 bar, in particular from 300 to 1000 bar, and particularly preferably from 300 to 800 bar, these values being those appropriate to the injection molding machine (depending on component parameters).

The clamping pressure (clamping force) for the mold can be reduced down to 30%, advantageously down to 25%, in particular down to 10%, when comparison is made with the known processes using a pure polyacetal melt, and is generally in the range from 500 N (0.05 metric ton/cm²) to 10000 N (1 metric ton/cm²), advantageously from 1000N (0.1 metric ton/cm²) to 7000 N (0.7 metric ton/cm²), in particular from 1200 N (0.12 metric ton/cm²) to 6100 N (0.61 metric ton/cm²).

The melt temperature, measured at the outlet from the injection nozzle, can be within a wide range and depends on the proportion of fluid, the molar mass of the polyacetals, and also on additives, such as filler. The melt temperature is generally in the range from 150 to 250° C., preferably from 160 to 230° C., and particularly preferably in the range from 175 to 210° C., with no intended resultant restriction.

The mold temperature may likewise be within a wide range. Without any intended resultant restriction, the mold temperature is in the range from 20 to 160° C., in particular from 40 to 140° C., and particularly preferably from 60 to 120° C.

The fluid used may in principle be any of the suitable fluids. The term “fluid” is intended to indicate that the gas or the liquid is in the supercritical state. These fluids are known per se, and the supercritical data for the substances, i.e. each supercritical pressure or supercritical temperature, can generally be found in tables or reference works.

Among the preferred substances which may serve as fluid are carbon dioxide (CO₂), nitrogen, dinitrogen monoxide, ethylene, propane, and ammonia, but preference is given to atmospheric gases, In particular carbon dioxide and nitrogen.

By way of example a change of temperature and pressure to 31° C. and 74 bar is sufficient for carbon dioxide to be in the supercritical state, The critical temperature is therefore only slightly above customary room temperature. The same applies to the critical pressure of 74 bar. Table 1 summarizes important data for carbon dioxide and nitrogen in the supercritical state.

TABLE 1
Important data for CO₂ and N₂ in the supercritical state

| | Nitrogen | | Carbon dioxide | |
|---|---|---|---|---|
| T_{crit} | −146.89° | C. | 31.06° | C. |
| | −233° | F. | 88° | F. |
| | 126.26 | K | 304.21 | K |
| P_{crit} | 34 | bar | 73.83 | bar |
| | 500 | psi | 1050 | psi |

| | | |
|---|---|---|
| Degree of | about 1.5% | about 6% |
| saturation in melt | | |
| Use for | production of relatively | 1. major weight reduction |
| | small cell structures | 2. high wall thickness |

In order that supercritical gases can be handled within injection molding technology, particular machine technology is needed. At first the plastics pellets are melted, as usual in customary Injection molding. In the cylinder of the injection molding machine, the supercritical gases are then introduced into the thermoplastic melt. In order to keep the pressure within the cylinder stable—i.e. prevent premature escape of the supercritical gas—the cylinder has to be gas-tight. The mixture composed of melt and supercritical gas is then injected at high speed and high pressure into the mold. The molds and machines are known and are described byway of example in WO 00173036 and WO 00/59702.

After cooling off the molding, it is removed from the mold, whereupon the gas spontaneously escapes into the environment after a short time.

The moldings of the present invention can in particular be used in automotive construction, in the construction industry and in the sanitary sector.

The invention is illustrated in further detail below via inventive examples and comparative examples, but there is no intention that the invention be restricted to these examples.

### INVENTIVE EXAMPLE 1

Injection experiments using Hostaform C9021 AW polyoxymethylene (POM) obtainable from Ticona GmbH were carried out on a complex engineering part with dimensions 90×120 mm and with an average wall thickness of 2 mm, with snap hooks and screw domes. The flow path length of the component was about 10 mm. The wall thickness at the thinnest location of the component was 1 mm, but the maximum wall thickness was 4 mm. The injection molding was carried out on a KM 150520/90 machine obtainable from Krauss Maffei. The melt temperature was about 180° C. and the mold temperature was about 60° C. The fluid used comprised nitrogen, and the melt here comprised 0.1% by weight of fluid. The result was a molding which had a screw-insertion torque of 2.7 Nm and an overtorque of 8.7 Nm, measured with 2 D screw-insertion depth and 500 rpm at 23° C.

The strength of the complex component was measured in a quasi-stationary tensile test, using a Bowden cable nipple, diameter 3 mm, at 23° C. with a tensile testing speed of 10 mm/min, and based on the cross-sectional area of the nipple. The strength was 338 MPa, and the molding here weighed 45 g.

### COMPARATIVE EXAMPLE 1

Example 1 was substantially repeated, but no fluid was added. A molding weighing 50 g was obtained, its screw-insertion torque being about 2.4 Nm and its overtorque being 7.5 Nm. The corresponding strength was 336 MPa.

### INVENTIVE EXAMPLE 2 AND COMPARATIVE EXAMPLE 2

In this experiment, intrinsic stresses and chemicals resistance were determined in an acid immersion test on the moldings produced in inventive example 1 or comparative example 1. The parts were immersed in 50% strength sulfuric acid for 5 min and assessed within the next 5-10 min. Visible cracking was used as assessment criterion. The moldings produced in comparative example 1 behaved identically here, and cracks immediately appeared at wall-thickness differences, corners and edges. No cracks could be found after this period on the moldings of inventive example 1. The parts were then immersed for 10 min, and even after this time no cracks could be found. The parts were therefore stored for about 20 hours and then again assessed. In the case of the moldings produced in comparative example 1 an enormous increase in cracking was apparent, distributed over the entire part. Cracking on the entire part could also be found after this storage period on the moldings of inventive example 1, but the extent and frequency of cracking are substantially smaller than for the compact parts produced in comparative example 1.

1-20. (canceled)

21. A process for producing a molding comprising:
forming a thermoplastic melt comprising a polyacetal polymer;
adding an amount of from 10⁻⁸ to 5% by weight of the thermoplastic melt of a supercritical fluid thereby dissolving said fluid in the thermoplastic melt, the thermoplastic melt being at a temperature above the critical temperature and the pressure above the critical pressure of the supercritical fluid;
injecting the thermoplastic melt and supercritical fluid into a mold, the injection conducted at a pressure of 45% or less than an the injection pressure required of a polyacetal thermoplastic melt absent said supercritical fluid, the mold receiving said injection at a temperature of from 20° C. to 160° C.;
applying a mold clamping pressure of 30% or less than the clamping pressure required of a polyacetal thermoplastic melt absent said fluid;
forming a molding, and
removing the molding from the opened mold, wherein the supercritical fluid is spontaneously released from the molding forming a microcellular structure within the molding.

22. The process for producing a molding as in claim 21, wherein upon addition of the supercritical fluid, the viscosity of the thermoplastic melt is reduced by up to 60%.

23. The process for producing a molding as in claim 21, wherein a clamping pressure for the mold is from 500 N to 10,000 N.

24. The process for producing a molding as in claim 21, wherein the melt temperature, measured at the outlet of an injection nozzle during injection of the thermoplastic melt into the mold, is from 150° C. to 250° C.

25. The process for producing a molding as in claim 21, wherein the supercritical fluid is selected from the group consisting of carbon dioxide, nitrogen, dinitrogen monoxide, ethylene, propane, ammonia, and combinations thereof.

26. The process for producing a molding as in claim 21, further comprising forming at least one perforation in the molding.

27. The process for producing a molding as in claim 21, wherein the molding has an average wall thickness from 0.1 mm to 100 mm.

28. The process for producing a molding as in claim 21, wherein the flow path length is from 1 mm to 250 cm.

29. The process for producing a molding as in claim 21, wherein the molding is formed with a minimum wall thickness and a maximum wall thickness, the difference between the minimum and maximum wall thicknesses being at least about 3 mm.

30. The process for producing a molding as in claim 21, wherein the ratio of flow path length to wall thickness is from 1:1 to 500:1.

31. The process for producing a molding as in claim 21, wherein the polyacetal comprises from 0.1 to 20 mol % of repeat units of the general formula 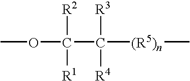
wherein R¹ to R⁴ are independently selected from the group consisting of hydrogen, alkyl group, and halogen-substituted alkyl groups containing from 1 to 4 carbon atoms; R⁵ is selected from the group consisting of —CH₂—, —CH₂O—, alkyl group containing from 1 to 4 carbon atoms, and haloalkyl-substituted methylene groups containing from 1 to 4 carbon atoms; and n is a whole number from 0 to 3.

32. The process for producing a molding as in claim 21, wherein the microcellular structure is generally uniform throughout the molding.

33. The process for producing a molding as in claim 21, wherein the density of the molding after formation of the microcellular structure is 10% to 25% less than the density of a corresponding solid molding.

34. The process for producing a molding as in claim 21, wherein the molding further comprises a metal, the molding constructed by metal overmolding.

35. A process for producing a molding comprising:
forming a thermoplastic melt, the thermoplastic melt comprising at least 70% by weight of a polyacetal polymer having a melting point from 140° C. to 180° C., a number-average molecular weight from 2,000 to 200,000, and a volume flow index from 1 cm³/10 min to 70 cm³/10 min;
dispersing a supercritical fluid into the thermoplastic melt, the supercritical fluid comprising nitrogen, carbon dioxide, or combinations thereof, the supercritical fluid comprising from 10⁻⁸% to 5% by weight of the thermoplastic melt, the thermoplastic melt being at a temperature above the critical temperature and the pressure above the critical pressure of the supercritical fluid;
injecting the thermoplastic melt and supercritical fluid into a mold to form a molding, wherein the injection pressure required to inject the thermoplastic melt into the mold is 45% or less than an injection pressure required of a pure polyacetal thermoplastic melt, wherein the molding is formed with a minimum wall thickness and a maximum wall thickness, the difference between the minimum and maximum wall thicknesses being at least about 3 mm;
applying a clamping force to the molding, the clamping force for the molding being 30% or less than a clamping force required for a pure polyacetal thermoplastic melt; and
removing the molding from the mold, wherein the supercritical fluid is spontaneously released from the molding forming a microcellular structure within the molding, wherein the density of the molding after formation of the microcellular structure is 10% to 25% less than the density of a corresponding solid molding.

36. The process for producing a molding as in claim 35, wherein the thermoplastic melt comprises at least 95% by weight of the polyacetal polymer.

37. The process for producing a molding as in claim 35, wherein upon addition of the supercritical fluid, the viscosity of the thermoplastic melt is reduced by up to 60%.

38. The process for producing a molding as in claim 35, wherein a clamping pressure for the mold is from 500 N to 10,000 N.

39. The process for producing a molding as in claim 35, further comprising forming at least one perforation in the molding.

40. The process for producing a molding as in claim 35, wherein the molding further comprises a metal, the molding constructed by metal overmolding.
